(19) United States
(12) Patent Application Publication
(10) Pub. No.: US 2010/0147066 A1
(43) Pub. Date: Jun. 17, 2010

(54) METHOD OF DETERMINING END MEMBER CONCENTRATIONS

(75) Inventor: Murtaza Ziauddin, Abu Dhabi (AE)

Correspondence Address: Schlumberger Technology Corporation, P. O. Box 425045, Cambridge, MA, 02142, US

(73) Assignee: SCHLUMBERGER TECHNOLOGY COPORATION, Cambridge, MA (US)

(21) Appl. No.: 12/335,884

(22) Filed: Dec. 16, 2008

(51) Int. Cl. G01F 1/00

(52) U.S. Cl. 73/152.29

(57) ABSTRACT

A method of determining a concentration of a component in a flow from a single source or layer contributing to a total flow is described using the steps of repeatedly changing the relative flows from the source; and for each of the changed relative flows determining the combined flow rate and a total concentration of the component of the total flow until sufficient data points are collected to solving a system of mass balance equations representing the flow of the component from each source at each of the changed flow rates.

### FIELD OF THE INVENTION

The invention relates to methods of determining the number of distinct subterranean sources or zones contributing to a total production flow and/or allocating the relative contributions of two or more distinct sources in a well or several wells to the total flow based on compositional analysis or compositional fingerprinting.

### BACKGROUND

In hydrocarbon exploration and production there is a need to determine the approximate composition of oil samples in order to investigate their origin and properties. The production systems of developed hydrocarbon reservoirs typically include pipelines which combine the flow of several sources. These sources can be for example several wells or several producing zones or reservoir layers within a single well. It is a challenge in the oilfield industry to back allocate the contributions of each source from a downstream point of measurement at which the flow is already commingled.

Other than for back allocation, composition analysis of single sources or layers can be used to study further phenomena such as reservoir compartmentalization, invasion or clean-out of drilling fluid filtrates.

It is further known that oil samples can be analyzed to determine the approximate composition thereof and, more particularly, to obtain a pattern that reflects the composition of a sample known in the art as fingerprinting. Such geochemical fingerprinting techniques have been used for allocating commingled production from multilayered reservoirs.

There are many known methods of fingerprinting. Most of these methods are based on using a physico-chemical method such as gas chromatography (GC), mass spectroscopy or nuclear magnetic resonance or others in order to identify individual components of a complex hydrocarbon mixture and their relative mass. In some known applications, a combination of gas chromatograph and mass spectroscopy (GC-MS) is used to detect spectra characteristic of individual components of the complex hydrocarbon mixture.

Most fingerprinting techniques as known in the art are based on the identification and quantification of a limited number of selected components which act as geomarker molecules. Such methods are described in U.S. Pat. No. 5,602,755 to Ashe et al. and in the published International Patent Application WO 2005/075972. Further methods of using compositional analysis for the purpose of back allocating well production are described for example in the U.S. Pat. No. 6,944,563 to Melbø et al.

Conventional methods of production allocation by geochemical fingerprinting techniques require the collection of end member fluid samples (single zone fluid samples) prior to back allocation of commingled fluids mostly through downhole sampling. Tool runs for downhole sampling are complex, expensive and may not be feasible in many scenarios, and therefore limit the general application of the known geochemical fingerprinting techniques for production allocation.

In a different branch of oilfield technology there is known a family of methods commonly referred to as production logging. Production logging is described in its various aspects in a large body of published literature and patents. The basic methods and tools used in production logging are described for example in U.S. Pat. No. 3,905,226 to Nicholas and U.S. Pat. No. 4,803,873 to Ehlig-Economides. Among the currently most advanced tools for production logging is the FlowScanner™ of Schlumberger.

In the light of the known methods it is seen as an object of the present invention to provide a method of determining the number of contributing subterranean sources or zones to a total flow and/or the end member concentrations using geochemical fingerprinting methods without the need for prior knowledge or collection of end member fluid samples.

### SUMMARY OF INVENTION

This invention relates to a method of determining a concentration of a component in a flow from a single source or layer contributing to a total flow using the steps of repeatedly changing the relative flows from the source; and for each of changed relative flows determining the combined flow rate and a total concentration of the component of the total flow until sufficient data points are collected to solve a system of mass balance equations representing the flow of the component from each source at each of the changed flow rates.

Accordingly, the present invention provides a method for production allocation by geochemical fingerprinting without the collection of end member samples of the geomarkers to be used, and hence offers a significant advantage over conventional methods.

The change of the relative flow rates means that when the flows are changed, the changed flow rates are not related to the old flow rate by a common factor. Hence when establishing the mass balance equation for the changed flow rates, it becomes linearly independent of the mass balance equations for the previous flow rates.

Such a change in the relative flow rates can be achieved through various methods and apparatus including the use of surface chokes, downhole plugs and valves. But it can also be caused by a successive opening or temporary blockage of the fluid communication between the sources and the total flow. In a variant of this method, such opening happens when a well is perforated such that after each perforation a zone or layer is added to the total production stream. The desired change in the flow rate can also be achieved by a stimulation treatment.

The sources are typically geochemically distinguishable layers or zones within a hydrocarbon reservoir. Geochemically distinguishable layers differ in the concentration of the geomarkers. In case that a reservoir is compartmentalized such that the same geochemically distinguishable layers or zones are produced through more than one well, it is possible to spread the measurements required for the new method between those wells.

In a preferred embodiment of the invention, the relative contributions of two or more producing subterranean sources are determined using the mass balance of the flows from the sources and the total flow, preferably as an overdetermined system of mass balance equations for the individual components of the total flow.

With a sufficient number of changes of the relative flow rates and/or a sufficient number of geomarkers used in the method, the system of mass balance equations can be solved even when the number of different sources or layers is an unknown. However, a solution of the system becomes easier and more accurate when the number of contributing sources is known. An even more preferred case for applying the novel method involves the step of measuring the flow rates of each contributing source or layer, thus eliminating the flow rates as unknowns through direct measurement. The flow rates of individual layers can be determined using production logging or similar methods. As a replacement for production logging, a variant of the invention envisages the use of Inflow Performance Relationships (IPRs) to successively determine the flow rates without having to perform downhole flow measurements at the level of each layer.

Prior knowledge of concentrations of components in flow of individual sources as gained for example from testing the individual sources using downhole testing or sampling devices can be advantageously applied to eliminate further unknowns from the system of equations.

In a further preferred embodiment of the invention, the concentrations of geomarkers as determined through the use of the novel method are applied to methods of back allocating production or determining flow rates of individual layers.

These and other aspects of the invention are described in greater detail below making reference to the following drawings.

### BRIEF DESCRIPTION OF THE FIGURES

FIGS. 1A-1C illustrate steps of a method in accordance with an example of the invention applied to a reservoir with three producing layers; and

FIG. 2 illustrates a step of a method in accordance with an example of the invention used to determine the number of sources or producing layers.

### DETAILED DESCRIPTION

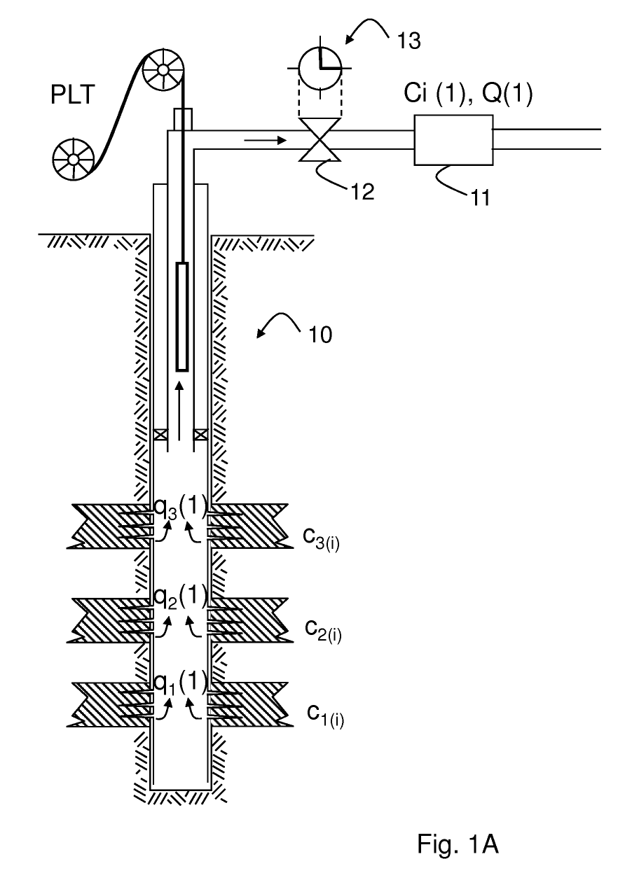

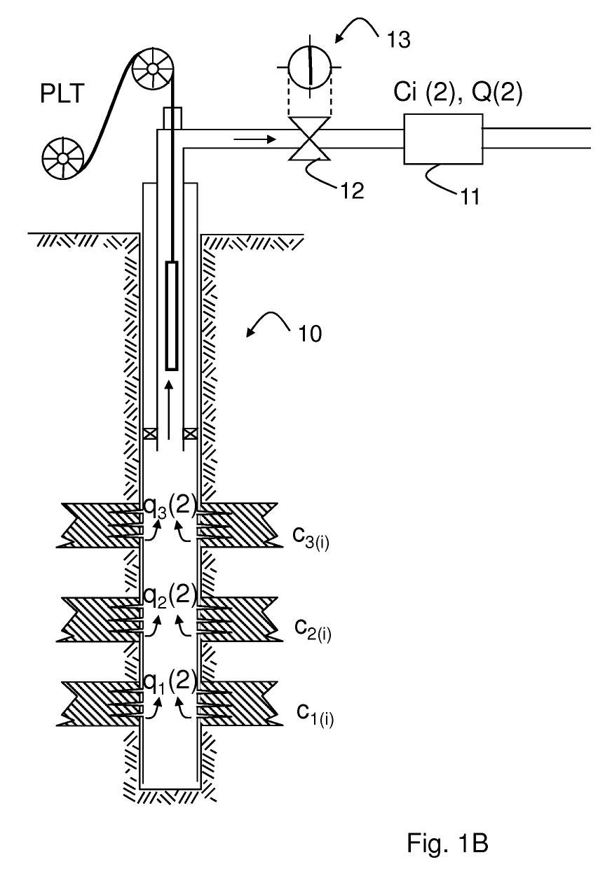

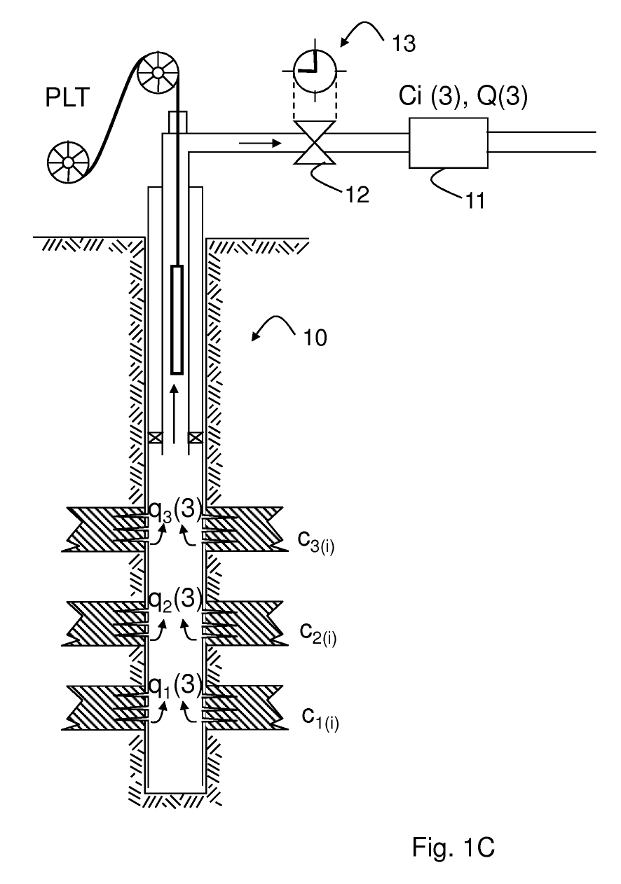

The method is illustrated by the following example, in which FIGS. 1A-1C shows an oil well 10 drilled in a formation containing several oil-bearing layers. In this example, the number of separate layers is chosen to be three to allow for a clearer description of elements of the present invention. However, the number of layers can vary and the below described example is independent of any specific number of layers.

In the example, there is assigned to each layer a flow rate q₁, q₂, and q₃, respectively. The fluids produced of the three layers contain chemical components at concentrations c₁ᵢ, c₂ᵢ and c₃ᵢ, respectively, wherein the index number i denotes a specific component i in the fluid.

In the present example, the component i stands for any component selected as geomarker for later application of a back allocation through fingerprinting. It will be apparent from the following description that the method can be applied to any number of such components or geomarkers as long as they are identifiable in the surface sample.

In accordance with known geochemical fingerprinting methods, the end member concentrations c₁ᵢ, c₂ᵢ and c₃ᵢ of a component i in the fluid would be determined using commercially available formation testing or sampling tools and methods, such as Schlumberger's MDT™. When using these methods, the tool samples each layer separately, thus rendering the process of analyzing the flows for the concentrations of geomarkers relatively straightforward.

However, the use of downhole sampling tools to determine end member concentrations is cost intensive and time consuming. The sampling step is a technically challenging operation inside the wellbore.

The example of the invention as described in following does not depend on the separate and individual sampling of the downhole layers. In more general terms, it is not required for the application of the present invention to have prior knowledge of the end member concentration and, in a variant, not even knowledge of the exact number of contributing layers.

Under normal production conditions, the combined flow is produced using subsurface and surface production facilities as shown in the FIG. 1. On the surface, there is shown a device 11 to measure the flow rate Q of the combined flow and the combined or total concentration Cᵢ of component i. Though shown in the schematic drawing as one device, the measurements of Q and Cᵢ may be taken at different locations and even different times (provided the flow conditions are sufficiently stable). The flow rates can be measured using any of the commercially available flowmeters such as Schlumberger's PhaseWatcher™. The flowmeter can be stationary or mobile.

The concentration measurements can be performed in situ or by taking samples for subsequent analysis in a laboratory. The concentration measurement itself can be based on optical, IR or mass spectroscopic, gas or other chromatographic methods or any other known method which is capable of discriminating between species and their respective amounts in the produced fluids. Though the exact method used to determine the concentrations is not a concern of the present invention, it appears that (at the present) GC-MS or GCxGC provide the best results.

The present example of the invention makes use of the basic equations which govern the transport of mass from the contributing sources or layers in the well to the point of measurement of the total flow. Using the notation as presented in FIGS. 1A-1C, these can be expressed for example as:

Mole/Mass balance: q₁c₁ᵢ+q₂c₂ᵢ+q₃c₃ᵢ=QCᵢ [1]

The conservation of mass requires

Mass conservation: q₁+q₂+q₃=Q. [2]

Again it should be noted that the above equation [1] applies to any component i of the produced fluid and that equations [1] and [2] can be readily extended to accommodate any number of sources by adding the respective flow rates.

In the present example the total flow rate Q of all phases of a multiphase flow and the total concentration Cᵢ of each component i are measured at the surface. To solve equation [1] for the concentration of the component i in the respective layers c₁ᵢ, c₂ᵢ and c₃ᵢ, a production logging tool (PLT) is applied to first determine the flow rates q₁ and q₂. The remaining flow rate q₃ can be either measured or derived from equation [2]. In case of a multiphase flow from a layer, the zonal flow rates q₁, q₂, and q₃ of this example are taken as the combined flow rates of all phases.

As one set of flow rates q₁, q₂, q₃ is not sufficient to determine the unknown concentration C₁ᵢ, c₂ᵢ and C₃ᵢ, the flow conditions in the well are altered such that relative flow rates q₁, q₂, and q₃ change. This change can be represented by a new equation of the type of equation [1] which is linearly independent from the first as will be explained below. In the example the minimum number of linearly independent equations required is equal to the number of sources.

The methods applied to change the relative flow rates of the downhole layers include steps which alter the flow conditions on the surface by, for example, using a variable flow restriction or pumps to change the pressure difference between the layers and the surface. The change introduced at surface can change the relative flow from each of the layers.

As an example, the sequence of FIGS. 1A-1C illustrates the effect of operating a choke valve 12 at the surface. A choke valve can be integrated into the surface production installation between the flow meter and the well. In FIG. 1A, he valve 12 is set to a first state as indicated by dial 13. In this state the flow measured is

q₁(1)c₁ᵢ+q₂(1)c₂ᵢ+q₃(1)c₃ᵢ=Q(1)Cᵢ [1A]

At this state a production logging tool is lowered into the well to determine the flowrates q₁(1), q₂(1), and q₃(1) of the single layers. Production logging is a standard and well established procedure to determine the contribution of single layers from a reservoir. For details on the tools and measurements used in production logging, reference is made to the above cited patents or to other relevant published documents such as “Profiling and Quantifying Complex Multiphase Flow” by J. Baldauff et al. in Oilfield Review Autumn 2004, pp. 4-13 (2004).

The total flow rate Q(1) can be measured from the surface as shown.

When set to a second state by either closing or opening the valve further as shown in dial 13 of FIG. 1B, the different pressure drop between the downhole layers and the surface causes a change in flow conditions and hence:

q₁(2)c₁ᵢ+q₂(2)c₂ᵢ+q₃(2)c₃ᵢ=Q(2)Cᵢ [1B]

as illustrated in FIG. 1B.

Again production logging is used to measure the changed flow rates q₁(2), q₂(2) and q₃(2).

Setting the valve to a third state as shown in dial 13 of FIG. 1C yields a third flow condition and hence:

q₁(3)c₁ᵢ+q₂(3)c₂ᵢ+q₃(3)c₃ᵢ=Q(3)Cᵢ [1C]

The changed flow rates q₁(3), q₂(3) and q₃(3) are then again measured using a PLT.

Under the condition that the relative flow rates from the layers change when the flow condition is changed, the equations [1A]-[1C] form a set of linear independent equation which can be solved for the unknown concentrations c₁ᵢ, c₂ᵢ and c₃ᵢ using for example known methods of solving a system of linear independent equations such as Gauss-Jordon Elimination, the Gauss-Seidel Iterative Method, LU Decomposition, or Singular Value Decomposition. Hence, as a result of solving the system of linear independent equations, the end member concentration c₁ᵢ, c₂ᵢ and C₃ᵢ of the component i is determined.

The above method and its results can be improved by using a higher number of flow changes than the minimal number as determined by the number of sources. With more changes of the relative flow rates, the system of mass balance equations [1] becomes overdetermined and, given the errors associate with each measurement, the confidence in the solution increases.

The above example can be varied in many aspects. Thus, it is for example possible to replace the production logging used to determine the flow rates by other types of measurements including for example the use of distinct tracers for each producing layer which bleed slowly into the flow and the concentration of which can be readily determined on the surface. For a variant of this method reference is made to the U.S. Pat. No. 6,645,769 to Tayebi et al. and commercial offerings of Resman, a company based in Trondheim, Norway.

Another method of measuring flow rates can be based on Temperature Sensing (DTS). The DTS methods employ an optical fiber cable run along the downhole production installation to sense temperature changes, which in turn can be converted into flow velocities and rates. An example of DTS is described in relevant published documents such as “Advances in Well and Reservoir Surveillance” by M. Al-Asimi et al. in Oilfield Review Winter 2002/3, pp. 14-35 (2003) and patents such as the U.S. Pat. No. 6,920,395 to Brown.

While changing the surface choke valve provides a ready way of changing flow conditions, other methods can be used to similar effect. Such methods include the use of downhole valves systems or methods which temporarily block the flow of single layers, effectively setting its flow rate to zero. Among the latter methods are temporary plugs using sand or polymer-based plugs, which can be easily removed from a well. The plugging sequentially blocks layers starting from the lowest, while removing the plugging material frees the flow again, but in reverse order. Such operations result in a set of equations such as [1A]-[1C]. It is also possible to exploit the effects of standard formation stimulation treatments which typically change the flow from each layer differently, thus changing the relative flow rate of each layer compared to those before the stimulation treatment. Suitable stimulations treatments include fracturing and/or matrix acidization.

Where a well is perforated sequentially layer-by-layer, the flow condition changes whenever a new layer is connected to the well. Using a standard surface measurement, the so-called Inflow Performance Relation (IPR) each time a new layer is added, the added flow plus the sum of the flow from all previous layers is linked by an IPR function. Thus for first layer q1 equals the measured total flow rate at a Bottom Hole Pressure BHP1. When the flow from a second layer is added, it gives rise to an IPR which is a function of the total flow Q=q′₁+q₂, i.e. IPR (q′₁+q₂) at a changed pressure BHP2. Hence, the q′₁ is in general not equal the previously measured q1. However, exploiting that BHP2 equals BHP1 reduced by the static pressure difference caused by the difference in depth of layer 1 and layer 2 (and some friction losses), the IPR (q′₁+q₂) function can be determined for the pressure BHP1, at which the q′₁ is closer to the known q₁. With q1 known the IPR (q′₁+q₂) at BHP1 becomes a function which can be solved for q₂.

The above steps can be applied successively to each new layer in order to determine the flow rate of this new layer based on the known flow rates of the layers already perforated and successive IPR curves. Hence, a successive determination of IPR functions as layer after layer is connected to the total flow enables the determination of the flow rates of the layers and, solving the system of mass balance equations as described in the previous example, ultimately the determination of the end member concentrations without downhole flow rate measurement.

For further details on the measurement and known use of IPRs reference is made to for example U.S. Pat. No. 4,803,873 to Ehlig-Economides, U.S. Pat. No. 7,089,167 to Poe, U.S. patent application Ser. No. 12/137,756 filed Jun. 12, 2008 to Poe and Meyer and Society of Petroleum Engineers (SPE) papers no. 10209, 20057, 48865 and 62917.

Instead of changing the flow condition in one well, measurements may be taken from different wells within the same compartment of the reservoirs. This variant of the invention assumes firstly the flow condition and hence the relative flow rates of the layers differ from well to well and secondly that within a compartment the end member composition of the layers are identical.

In an even more generalized application of the new method, the flow condition and hence the relative flow rates are changed and a sufficiently large number of components i are measured to solve the above system of mass balance equation without knowledge of the flow rates and, in an extension, without even knowledge of the number of layers or sources.

In the latter case the number of unknowns is Nc×Nz+(Nz−1)×Nf while the measurements yield Nf×Nc data points, where Nc is the number of components i for which concentrations c are measured, Nz the number of sources and Nf the number of changes in the flow conditions or relative flow rates. As long as the latter term is equal or larger the former (thus Nf exceeding Nz), the system of mass balance equations can be solved starting for example by assuming first the existence of only one layer, and adding layers until the relative error of the solution approaches a constant.

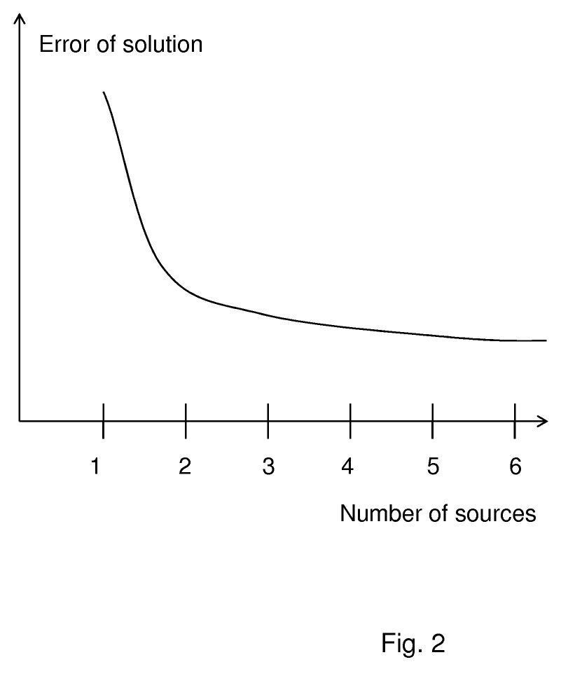

This process is illustrated in FIG. 2. In the example, three or four layers are the likely number of layers or sources.

In an extension of the methods of this invention, the concentration can be used for back allocation purposes. The equations [1A]-[1C] can also be used to determine the zonal flow rates, once the end member compositions are established and can be assumed to remain stable over the period of observation.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative processes, one skilled in the art will recognize that the system may be embodied using a variety of specific procedures and equipment and could be performed to evaluate widely different types of applications and associated geological intervals. Accordingly, the invention should not be viewed as limited except by the scope of the appended claims.

What is claimed is:

1. A method of determining relative contributions of two or more subterranean sources to a total flow, the method comprising the steps of
repeatedly changing the relative flow rates from said producing sources; and
for each changed flow rate measuring the total flow rate and a total concentration of one or more flow components used as geomarkers within said total flow, until sufficient measurements are made to solve a system of mass balance equations representing a flow of said one or more flow components from each of such layers at each of said changed relative flow rates.

2. A method in accordance with claim 1, including the step of determining the number of sources.

3. A method in accordance with claim 1, including the step of determining the end member concentration of the one or more components used as geomarkers.

4. A method in accordance with claim 1, including the step of determining simultaneously the end member concentration of the one or more components used as geomarkers and the number of sources.

5. A method in accordance with claim 1, including the step of determining a flow rate of each source using a production logging method.

6. A method in accordance with claim 5, including the step of suspending a production logging tool into a well to determine the flow rate of each source after each change of the relative flow rates.

7. A method in accordance with claim 1, wherein a flow rate of each source is determined using a successive opening of the sources and a determination of the Inflow Performance Relationship after each opening.

8. A method in accordance with claim 1, wherein the relative flow rates are changed using one or more choke valves at surface locations.

9. A method in accordance with claim 1, wherein the relative flow rates are changed by restricting or increasing the flow between a source and a well carrying the total flow.

10. A method in accordance with claim 9, including the step of using a stimulation treatment in the well.

11. A method in accordance with claim 9, including the step of using a temporary plug between the source and the well.

12. A method in accordance with claim 9, including the step of successively perforating the well to open one source after the other.

13. A method in accordance with claim 1, wherein the step of changing the relative flow rates from the sources includes measurements from different wells, said wells sharing the same sources at different flow rates.

14. A method in accordance with claim 1, wherein sources are hydrocarbon producing zones or layers.
